(19) United States
(12) Patent Application Publication
(10) Pub. No.: US 2024/0025774 A1
(43) Pub. Date: Jan. 25, 2024

(54) METHOD AND SYSTEM FOR ACHIEVING HIGH CONCENTRATIONS AND RECOVERIES FROM MEMBRANE SYSTEMS USING INTERNAL PRESSURE BOOSTING PUMPS AND FLOW CONTROL

(71) Applicant: High Bar Membrane Systems LLC, Coral Springs, FL (US)

(72) Inventors: Larry Lien, Solana Beach, CA (US); Doug Vanderlinden, Burlington (CA)

(21) Appl. No.: 18/356,459

(22) Filed: Jul. 21, 2023

Related U.S. Application Data
(60) Provisional application No. 63/391,658, filed on Jul. 22, 2022.

(51) Int. Cl. C02F 1/44

(52) U.S. Cl. CPC C02F 1/441; C02F 1/442; C02F 1/444; C02F 2101/10

(57) ABSTRACT

A system and/or method of recovering a metal, a mineral, a salt, and/or a lithium compound from a feed stream, the system comprising a multi-stage membrane system with inner stage pressure boosting pumps, and at least one energy recovery device transferring hydraulic energy from a concentrate stream to a feed stream of at least one of the membrane systems.

### CROSS-REFERENCE TO RELATED APPLICATION

This application claims priority under 35 U.S.C. § 119(e) to U.S. Provisional Application 63/391,658 filed on Jul. 22, 2022. The disclosure of this prior application is considered part of the disclosure of this application and is hereby incorporated by reference in its entirety.

### TECHNICAL FIELD

The present disclosure relates to methods for the recovery of a metal, a mineral, a salt, and/or a lithium compound, such as lithium from lithium-containing materials, solutions, and/or fluids, and more particularly, the recovery of metals, metals, minerals, and/or salts utilizing staged membrane separation with internal pressure boosting and energy recovery.

### BACKGROUND

High purity and highly concentrated lithium is becoming essential as the world moves away from fossil fuels and pivots to vehicle electric power. Currently, lithium recovery and extraction takes place in naturally occurring salt brine deposits and often in remote areas throughout the world. These deposits are pumped to the surface and can be treated to yield lithium carbonate, which can then be more economically transported worldwide to battery processors for further refining and battery production. When salt brines are not purified before lithium carbonate is created, they contain significant amounts of undesirable contamination including relatively high levels of calcium, magnesium, potassium and boron that must be removed. Initial purification steps used progressive, isolated evaporation processes whereby lithium contaminants are successively removed as they reach their respective solubility limits. This process takes up to 15 months and requires significant footprints. As such, the lithium industry seeks a scalable, high capacity lithium brine purification system that can operate in remote areas and does not require the extensive power or footprints that evaporation process demand.

### SUMMARY

In one approach or embodiment, a method of recovering a metal, a mineral, a salt, and/or a lithium compound from a feed stream is described herein. In one aspect, the method includes a multi-stage membrane system with inner stage pressure boosting pumps, and at least one energy recovery device transferring hydraulic energy from a concentrate stream to a feed stream of at least one of the membrane systems. In another aspect, the method further includes directing the feed stream to a first membrane providing a first concentrate and a first permeate, directing the first concentrate to a first inner stage pressure boosting pump before a second membrane providing a second concentrate and second permeate, directing the second concentrate to a second inner stage pressure boosting pump before a third membrane providing a third concentrate and third permeate, and recovering the metal, the mineral, the salt, and/or the lithium compound from the third concentrate.

In other approaches or embodiments, the methods of the previous paragraph may include one or more optional embodiments or features in any combination. The optional features or embodiments may include one or more of the following: wherein the first membrane operates at about 100 to about 600 psi, the second membrane operates at about 1000 to about 1200 psi, and/or the third membrane operates at about 1500 to about 1800 psi; and/or wherein the feed pressure to any membrane or membrane stage is at or, in some embodiments, above the osmotic pressure of the feed solution to that particular membrane; and/or wherein the pressure of the second concentrate after the second inner stage boosting pump is further increased by the at least one energy recovery device to achieve the pressure of the third membrane such that the boost pressure of the second inner stage boosting pump is about 25 to about 50 percent lower than the first inner stage boosting pump; and/or wherein the at least one energy recovery device is a turbine, a pelton wheel, a turbocharger device, a rotary-driven energy transfer device, or a piston-driven transfer device; and/or wherein the pressure of the third membrane is about 1.2 to about 1.8 times higher than the second membrane, and/or wherein the pressure of the second membrane is about 2 to about 12 times higher than the first membrane; and/or wherein each of the first membrane, the second membrane, and the third membrane, independently, is one of an ultrafiltration membrane, a nanofiltration membrane, or a reverse osmosis membrane; and/or wherein the first permeate, the second permeate, and the third permeate are combined; and/or wherein about 0.1 to about 1 gram/liter of a metal, a mineral, a salt, or a lithium compound (preferably a lithium compound in the form of lithium carbonate, lithium sulfonate, lithium chloride, and the like) in the feed stream is concentrated to about 7 to about 15 grams/liter in the concentrate steam from the third membrane system; and/or wherein the feed stream is a salt-lake brine, a coal-fired plant flue-gas scrubber blowdown water, a high-salinity brine source, a brine water-source from an underground mine, and/or combinations thereof; and/or wherein the metal, the mineral, or the salt concentrated by the methods herein and is one of copper, a gold compound, a silver compound, ammonium sulfate, glycols, sugars, rare earth elements, and the like compounds, or combinations thereof; and/or wherein the mineral is lithium, lithium chloride, lithium carbonate, lithium sulfate, or combinations thereof.

In another approach or embodiment, a system of recovering a metal, a mineral, a salt, and/or a lithium compound from a feed stream is described herein. In one aspect, the system includes a multi-stage membrane system with inner stage pressure boosting pumps, and at least one energy recovery device transferring hydraulic energy from a concentrate stream to a feed stream of at least one of the membrane systems. In another aspect, the system further includes a first membrane to separate a feed stream into a first concentrate and a first permeate, a first inner stage pressure boosting pump to increase the pressure of the first concentrate, a second membrane separating the pressure boosted first concentrate into a second concentrate and second permeate, a second inner stage pressure boosting pump to increase the pressure of the second concentrate, a third membrane separating the pressure boosted second concentrate into a third concentrate and third permeate, and recovering the metal, the mineral, the salt, and/or the lithium compound from the third concentrate.

In other embodiments or approaches, the systems of the previous paragraph may include one or more optional features or embodiments in any combination. These optional features or embodiments may include one or more of the following: wherein the first membrane operates at about 100 to about 600 psi, the second membrane operates at about 1000 to about 1200 psi, and/or the third membrane operates at about 1500 to about 1800 psi; and/or wherein the feed pressure to any membrane is at or, in some embodiments, above the osmotic pressure of the feed stream to the particular membrane; and/or wherein the pressure of the second concentrate after the second inner stage boosting pump is further increased by the at least one energy recovery device to achieve the pressure of the third membrane such that the boost pressure of the second inner stage boosting pump is about 25 to about 50 percent lower than the first inner stage boosting pump; and/or wherein the at least one energy recovery device is a turbine, a pelton wheel, a turbocharger device, a rotary-driven energy transfer device, or a piston-driven transfer device; and/or wherein the pressure of the third membrane is about 10 to about 18 times higher than the first membrane, wherein the pressure of the third membrane is about 1.2 to about 1.8 times higher than the second membrane, and/or wherein the pressure of the second membrane is about 2 to about 12 times higher than the first membrane; and/or wherein each of the first membrane, the second membrane, and the third membrane, independently, is one of an ultrafiltration membrane, a nanofiltration membrane, or a reverse osmosis membrane; and/or wherein the first permeate, the second permeate, and the third permeate are combined; and/or wherein about 0.1 to about 1 gram/liter of lithium in the feed stream is concentrated to about 7 to about 15 grams/liter in the concentrate steam from the third membrane system; and/or wherein the feed stream is a salt-lake brine, a coal-fired plant flue-gas scrubber blowdown water, a high-salinity brine source, a brine water-source from an underground mine, and/or combinations thereof and/or wherein the metal, the mineral, or the salt concentrated by the methods herein and is one of copper, a gold compound, a silver compound, ammonium sulfate, glycols, sugars, rare earth elements, and the like compounds, or combinations thereof and/or wherein the mineral is lithium, lithium chloride, lithium carbonate, lithium sulfate, or combinations thereof.

### BRIEF DESCRIPTION OF THE FIGURES

FIG. 1 is a flow diagram of an exemplary staged membrane recovery method or system as described herein.

### DETAILED DESCRIPTION

The present disclosure describes methods of achieving high concentrations and recoveries of a metal, a mineral, a salt, and/or a lithium compound from membrane systems using internal pressure boosting and energy recovery. In one approach, the methods herein include semipermeable membrane technology operating in a multi-stage (preferably, a minimum of three stages) configuration having variable and rising pressures at each stage to create efficient and/or equal membrane recovery performance. In embodiments, the unique methods and systems herein produce high quality lithium based solutions in a single process with very low energy requirements.

For instance, it has been found that when cross flow semipermeable membrane filtration systems can be pressure controlled within each stage to match (or exceed) the influent osmotic pressure characteristics, they can provide highly effective cleaning of the contamination from lithium based solutions (or other solutions), and concentrate the feed stream up to 90% at very high throughput rates. The pressure at each stage may be set by a processor and/or pressure control loop which varies pump speed at each stage to create equal membrane rates (that is, permeate gallons per stage/feed gallons per stage).

The staged systems herein with inner stage pressure boosting offers very high recovery rates of the target metal, target mineral, or target salt to be recovered (such as, in one embodiment, lithium, lithium carbonate, or lithium sulfate) in the feed solutions, while removing 75 to 95% of typical contaminants including magnesium, calcium, and other undesired metals, minerals, and salts (via, for example, the permeate), while using minimal power per gallon processed. The systems herein are capable of automatically matching the rising and ultimately very high osmotic pressures associated with both sodium chloride and lithium (or lithium salts) as concentrations rise, but also control pressures initially, since the influent concentrations are low and also may vary significantly due to upstream processes. In some approaches, the methods herein achieve very high recovery rates with the final recovery stage operating at feed pressures between about 1,400 psi and about 1,800 psi. With the novel systems herein, the feed pressure at any stage, may be boosted sequentially at each stage, by the concentrate of the previous stage, so that energy required per gallon produced is considerably lower than individually staged processes. As such, the methods, systems, and/or plant designs require considerably less components and/or footprints are more compact.

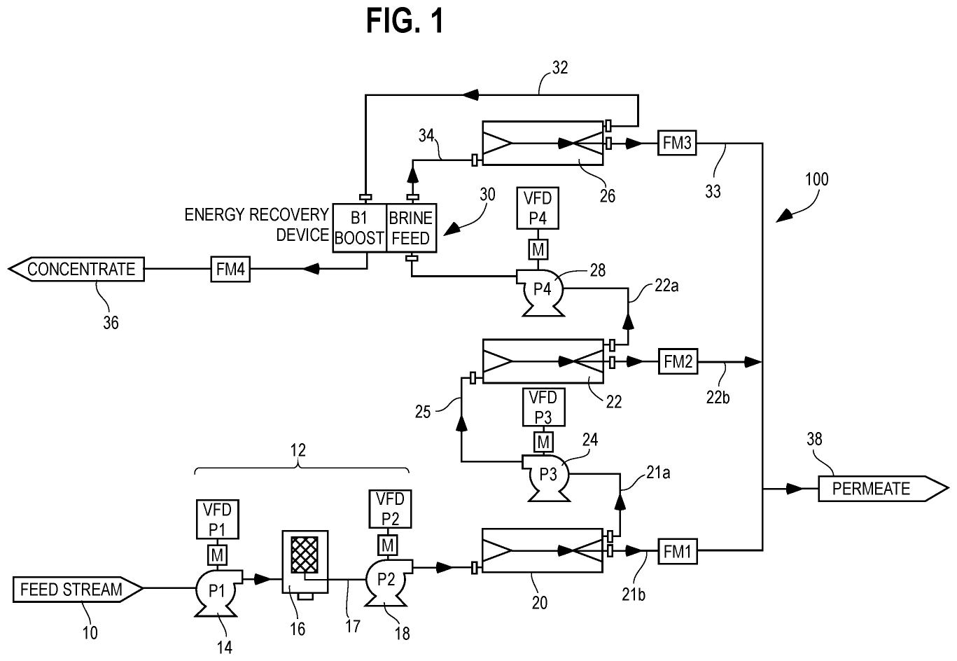

Turning to FIG. 1, an exemplary staged membrane system method or system 100 is shown with internal stage pressure boosting and energy recovery. As used herein, any of the described membrane processing stages herein may substantially retain or permeate various streams as described herein below. In this context, substantially means at least a majority or at least about 50 percent, in other approaches, at least about 70 percent, and in other approaches, at least about 90 percent retention or permeation as the case may be. In some approaches or embodiments, any of the membranes described herein may be semipermeable membranes and/or cross-flow membranes, and may include, for instance, ultrafiltration membranes, nanofiltration membranes, and/or reverse osmosis membranes. In approaches, any of the membranes herein may include but not be limited to, membranes with a polymeric base or barrier layer such as nylon, polysulfone, FRP (fiber reinforced plastic), ABS, and/or PVC materials. In some approaches, epoxy resins may be used to form the membrane tube, wrap, or frame of any membrane herein but other materials may also be used as needed for a particular application. In other approaches, any membrane herein may include an outer wrap or layer that may be polyurethane or polypropylene open mesh. Suitable membranes for any of the stages herein may be, but are not limited to, hollow fiber, spiral wound, plate and frame, cross-flow, or ceramic tube type membranes. In other approaches, materials for any membrane herein may also be, but are not limited to, polyvinylidene difluoride (PVDF), polyvinyl chloride (PVC), polyacrylonitrile (PAN), polysulfone (PSF), or polyethersulfone (PES) and the like materials. In some embodiments, any membrane herein may have, but are not limited to, a pore size of about 0.0007 to about microns or about 0.0005 to about 0.001 microns, and may be operated from about 200 to about 2000 psi, and in other approaches, about 200 to about 1800 psi, and in yet other approaches, about 500 to about 1000 psi. In some approaches, suitable membrane for any stage herein may include but are not limited to, nylon, sulfonated polysulfone, polyaramide and the like materials and may be commercially available from Toray, Hydranautics, Filmtec GE and other commercial membrane supplies to suggest but a few suppliers.

In any approach or embodiment herein, exemplary ultrafiltration membranes for use in any stage herein may have a pore size of about 0.01 microns to about 0.5 microns and may be operated at about 10 to about 100 psi as appropriate for the various stage in which it may be used. In any approach or embodiment herein, exemplary nanofiltration membranes (as modified herein or above as needed) for use in any stage herein may have a pore size of about 0.0007 microns to about 0.0012 microns and may be operated at about 200 to about 2000 psi and/or have up to about 300 molecular weight cut-off (pressures may be varied as needed depending on the various stage(s) as described below). In another approach or embodiment herein, exemplary reverse osmosis membranes for any stage herein may have a pore size of about 0.0005 microns to about 0.001 microns and may be operated at about 200 to about 2000 psi and/or have up to about 300 molecular weight cut-off (pressures may also be varied as needed pending on the various stage(s) as described below). Membrane sizes and operating pressures may be varied as needed for particular applications and/or use in the particular filter stage as described herein.

In some instances, commercially available membranes for any of the membrane stages herein may not sufficiently reject and pass the desired materials at high enough flow rates and, thus, may optionally be modified for use in the methods and systems herein to provide higher flow, better selectivity, and more rapid delivery of fluids. To better tailor the separation steps, modified membranes may be used in some approaches herein. For instance, any of the semi-permeable membranes herein may be a modified or chlorinated semi-permeable membrane, such as a chlorinated nanofiltration membrane or chlorinated reverse-osmosis membrane. The chlorinated membrane, more specifically, may be modified/chlorinated by soaking the membrane in about 2 to about 4 percent chlorine (at a pH of about 10 to about 12) for about 2 to about 4 hours at ambient temperature (about 20 to about 30° C.). After chlorination, the membrane may have a pore size of about 0.0007 to about 0.0012 microns and/or have a molecular weight cutoff of about 300 to about 400 daltons.

As shown in FIG. 1, a multi-stage system and/or method 100 is shown to recover a concentrate stream 36 from a feed stream 10 using multiple semipermeable membranes operating in a multi-stage configuration that uses variable and increasing pressures at each stage to concentrate a target mineral, target metal, target salt, or other targeted composition (such as, in one embodiment, lithium compounds). The methods and systems herein may be configured to concentrate a metal, a mineral, or a salt and, in some embodiments, may concentrate one of copper, gold, silver, ammonium sulfate, glycols, sugars, rare earth elements, or combinations thereof. In some embodiments, the target compound to be concentrated may be gold tetrachloride, gold sulfate, silver tetrachloride, silver sulfate, or mixtures thereof. In other embodiments, the methods and systems herein are configured to concentrate one of lithium, lithium carbonate, lithium chloride, lithium sulfate, or combinations thereof. The systems and methods herein include a feed stream 10, a pre-filter system 12, a first or low pressure membrane stage 10, a second or intermediate membrane stage 22, a third or high pressure membrane stage 26, and an output concentrate stream 36. Each of the streams and stages of the systems and methods herein will be described further below.

First, the feed stream 10 may include any feed source including the above noted metals, minerals, metals, and/or salts (such as, in one embodiment, a lithium compound such as lithium or lithium chloride) to be recovered and concentrated and, in some embodiments, may include about 0.1 to about 1 gram/liter of the minerals or salts to be recovered such as, in one embodiment, lithium in the form of lithium salts (e.g., lithium, lithium carbonate, lithium chloride, lithium sulfate, or combination thereof). In some approaches, the feed stream 10 may be a water source including, but not limited to, a salt-lake brine, a coal-fired plant flue-gas scrubber blowdown water, a high-salinity brine source, a brine water-source from an underground mine, and/or combinations thereof. For instance, the feed stream 10 may be a brine-water source, such as those from underground mines (lithium mines and the like), may include lithium and exemplary underground mine water sources may include, in some embodiments, from about 100 ppm to about 5000 ppm lithium, about 200 ppm to about 2500 ppm lithium, or even about 400 ppm to about 1500 ppm of lithium (as measured by AAS—the lithium may be as lithium salts such as lithium chloride, lithium sulfate, and/or the like). The methods and systems herein, in other approaches, may concentrate the lithium up to about 18,000 ppm or up to about 26,000 ppm of lithium (such as about 10,000 to about 26,000 ppm or about 15,000 to about 22,000 ppm, or about 16,000 to about 18,000 ppm) in stream 36.

In some approaches, the feed stream 10 may be processed with the prefilter system 12 that may include a pre-pump 14 and a prefilter 16 to remove suspended solids and other contaminates. Prefilter 16 may be any suitable filter, such as a filter press, to remove suspended solids. The permeate 17 from the prefilter 16 may be directed to a first stage pressure pump 18. The first stage pressure pump 18 operates to boost the pressure of the feed stream 10 to about 100 to about 600 psi, for instance, for the first membrane system or stage 20.

The first membrane or stage 20 may concentrate the metal, the mineral, the salt, or the lithium compound from the feed stream 10 up to about 3× (such as about 1.1× to about 3×, about 1.5× to about 3×, or about 2× to about 3×) from that in the feed stream 10. The first membrane or stage 20 forms a concentrate 21a and a permeate 21b. The target minerals, metals, or salts to be concentrated are substantially retained as defined above in the concentrate stream 21a.

The methods and systems herein then include a second membrane system or stage 22 with an inner-stage pressure boost pump 24 that is configured to boost the feed pressure of the concentrate stream 21a from the first stage before being feed to the second membrane 22. For instance, the inner-stage pressure boost pump 24 operates to increase the pressure of stream 21a, for instance, up to about 1000 to about 1200 psi as feed stream 25 to the second stage or second membrane system 22. This second membrane 22 may concentrate the metal, the mineral, the salt, or the lithium compound up to about 6× from its feed stream 25 (e.g., about 1× to about 6×, about 2× to about 6×, about 3× to about 6×, about 5× to about 6×, or about 5× to about 6×). Thus, the second stage 22 may operate at pressures that are about 2× to about 12× higher than the first stage 20 with use of the inner-stage pressure boost pump 24. The second membrane or stage 22 forms a concentrate 22a and a permeate 22b. The target minerals, metals, salts, or lithium compound to be concentrated are substantially retained as defined above in the concentrate stream 22a.

The concentrate 22a from the second membrane/stage 22 is then directed to a third membrane or stage 26 using another or a second inner-stage pressure boost pump 28 as well as an optional energy recovery device 30. For this third stage, the second inner-stage pressure boost pump and/or the combination of the boost pump 28 and the energy recovery device 30 increases the pressure of stream 22a, for instance, up to about 1500 to about 1800 psi as the feedstream 34 for the third membrane or stage 26. The third or final membrane may concentrate the metal, the mineral, the salt, or the lithium compound up to about 2× from its input stream 34 (such as about 1× to about 2×). The third membrane or stage 26 forms a concentrate 32 and a permeate 33. The target minerals, metals, salts, or lithium compound to be concentrated are substantially retained as defined above in the concentrate stream 32.

In approaches, the energy recovery device 30 uses the high energy or high pressure of the high pressure concentrate stream 32 from the third membrane 26 to aid in boosting pressure to the membrane 26 and, thus, lowering the energy needed to operate the boost pump 28. The energy recovery device is configured to transfer the hydraulic energy/pressure from the high-pressure concentrate stream 32 and transfer such energy to the feed stream 34. Exemplary energy recovery devices 30 may include, but are not limited to, any centrifugal-type devices, such as turbines, pelton-type wheels, turbocharger-type devices, rotary-driven energy transfer devices, or piston-driven transfer devices arranged and configured to transfer the hydraulic pressure and energy from the output stream 32 to the input stream 34, which lowers the boost needed from pump 28 making the entire system more energy efficient. In some approaches, the boost pressure of the third pump 28 may be lowered by about 25 to about 50% even when achieving the high pressure up to about 1800 psi to the third membrane. For instance, the pressure of stream 34 may be derived from both the pump 28 and the energy recovery device 20 with about 50 to about 75% of the pressure derived from the pump 28 and about 25 to about 50% of the pressure derived from the energy recovery device. Any stage herein may include the energy recovery device, but it is shown on the third stage and is most preferred to be used with the higher pressure and higher volume streams.

The methods herein provide energy efficiency for recovering a target metal, mineral, salt, and/or lithium compound. In some approaches, the pressures of the third stage are about 3× to about 18× higher than the pressure of the first stage and may be about 1.2× to about 1.8× higher than the pressures of the second stage. In some approaches, the staged pressures of the systems herein utilize a pressure ratio of fluid pressures of the third membrane to the second membrane to the first membrane of about 3:2:1 to about 7.5:5:1 or other ranges therein meaning the pressure to the third membrane may be about 1500 to about 1800 psi to the pressure of the second membrane of about 1000 to about 1200 psi to the pressure of the first membrane of about 200 to about 600 psi. In approaches, it is desired to keep the feed pressures at (or above) the osmotic pressures of the various feed streams to each membrane or membrane stage in aid in concentration and/or so that the soluble salts of each stream stay in solution when fed to each membrane. In one embodiment, the final concentrate stream 36 may have about 7 to about 15 grams/liter or, in other approaches, about 10 to about 12 grams/liter of the target metal, mineral, and/or salt (e.g., a lithium compound as described above), which may be, in one embodiment, in the form of lithium carbonate, lithium sulfate, lithium chloride, or other lithium salt (and/or the concentrate stream 36 may include the other amounts as described above).

As shown in FIG. 1, each of the permeate streams 21b, 22b, and 33 may be optionally be combined into a single permeate stream 38 for further use, recycle, or other processing as needed for a particular application including (for example) the removed contaminates of magnesium, calcium, potassium, boron, and the like minerals. In other approaches, any embodiment of the methods and systems herein are closed systems with little to no evaporation of the solvent or water.

It is to be understood that while the materials and methods of this disclosure have been described in conjunction with the detailed description thereof and summary herein, the foregoing description is intended to illustrate and not limit the scope of the disclosure, which is defined by the scope of the appended claims. Other aspects, advantages, and modifications are within the scope of the claims.

What is claimed is:

1. A method of recovering a metal, a mineral, a salt, and/or a lithium compound from a feed stream, the method comprising:
a multi-stage membrane system with inner stage pressure boosting pumps, and
at least one energy recovery device transferring hydraulic energy from a concentrate stream to a feed stream of at least one of the membrane systems.

2. The method of claim 1, further comprising directing the feed stream to a first membrane providing a first concentrate and a first permeate, directing the first concentrate to a first inner stage pressure boosting pump before a second membrane providing a second concentrate and second permeate, directing the second concentrate to a second inner stage pressure boosting pump before a third membrane providing a third concentrate and third permeate, and recovering the metal, mineral, salt, and/or the lithium compound from the third concentrate.

3. The method of claim 2, wherein the first membrane operates at about 100 to about 600 psi, the second membrane operates at about 1000 to about 1200 psi, and the third membrane operates at about 1500 to about 1800 psi.

4. The method of claim 3, wherein the pressure of the second concentrate after the second inner stage boosting pump is further increased by the at least one energy recovery device to achieve the pressure of the third membrane such that the boost pressure of the second inner stage boosting pump is about 25 to about 50 percent lower than the first inner stage boosting pump.

5. The method of claim 4, wherein the at least one energy recovery device is a turbine, a pelton wheel, a turbocharger device, a rotary-driven energy transfer device, or a piston-driven transfer device.

6. The method of claim 2, wherein the pressure of the third membrane is about 10 to about 18 times higher than the first membrane, wherein the pressure of the third membrane is about 1.2 to about 1.8 times higher than the second membrane, and/or wherein the pressure of the second membrane is about 2 to about 12 times higher than the first membrane.

7. The method of claim 2, wherein each of the first membrane, the second membrane, and the third membrane, independently, is one of an ultrafiltration membrane, a nanofiltration membrane, or a reverse osmosis membrane.

8. The method of claim 2, wherein the first permeate, the second permeate, and the third permeate are combined.

9. The method of claim 2, wherein about 0.1 to about 1 gram/liter of lithium in the feed stream is concentrated to about 7 to about 15 grams/liter in the concentrate steam from the third membrane system.

10. The method of claim 2, wherein the feed stream is a salt-lake brine, a coal-fired plant flue-gas scrubber blowdown water, a high-salinity brine source, a brine water-source from an underground mine, and/or combinations thereof.

11. A system of recovering a metal, a mineral, a salt, and/or a lithium compound from a feed stream, the system comprising:
a multi-stage membrane system with inner stage pressure boosting pumps, and
at least one energy recovery device transferring hydraulic energy from a concentrate stream to a feed stream of at least one of the membrane systems.

12. The system of claim 11, further comprising a first membrane to separate a feed stream into a first concentrate and a first permeate, a first inner stage pressure boosting pump to increase the pressure of the first concentrate, a second membrane separating the pressure boosted first concentrate into a second concentrate and second permeate, a second inner stage pressure boosting pump to increase the pressure of the second concentrate, a third membrane separating the pressure boosted second concentrate into a third concentrate and third permeate, and recovering the metal, the mineral, the salt, and/or the lithium compound from the third concentrate.

13. The system of claim 12, wherein the first membrane operates at about 100 to about 600 psi, the second membrane operates at about 1000 to about 1200 psi, and the third membrane operates at about 1500 to about 1800 psi.

14. The system of claim 13, wherein the pressure of the second concentrate after the second inner stage boosting pump is further increased by the at least one energy recovery device to achieve the pressure of the third membrane such that the boost pressure of the second inner stage boosting pump is about 25 to about 50 percent lower than the first inner stage boosting pump.

15. The system of claim 14, wherein the at least one energy recovery device is a turbine, a pelton wheel, a turbocharger device, a rotary-driven energy transfer device, or a piston-driven transfer device.

16. The system of claim 12, wherein the pressure of the third membrane is about 10 to about 18 times higher than the first membrane, wherein the pressure of the third membrane is about 1.2 to about 1.8 times higher than the second membrane, and/or wherein the pressure of the second membrane is about 2 to about 12 times higher than the first membrane.

17. The system of claim 12, wherein each of the first membrane, the second membrane, and the third membrane, independently, is one of an ultrafiltration membrane, a nanofiltration membrane, or a reverse osmosis membrane.

18. The system of claim 12, wherein the first permeate, the second permeate, and the third permeate are combined.

19. The system of claim 12, wherein about 0.1 to about 1 gram/liter of lithium in the feed stream is concentrated to about 7 to about 15 grams/liter in the concentrate steam from the third membrane system.

20. The system of claim 12, wherein the feed stream is a salt-lake brine, a coal-fired plant flue-gas scrubber blowdown water, a high-salinity brine source, a brine water-source from an underground mine, and/or combinations thereof.
